(19) United States
(12) Patent Application Publication
(10) Pub. No.: US 2024/0227908 A1
(43) Pub. Date: Jul. 11, 2024

(54) Universal Wheelbarrow Snowboard Attachment

(71) Applicant: James Laurence Dean Naylor, Sparta, NJ (US)

(72) Inventor: James Laurence Dean Naylor, Sparta, NJ (US)

(21) Appl. No.: 18/151,428

(22) Filed: Jan. 7, 2023

(51) Int. Cl. B62B 19/02; B62B 1/20

(52) U.S. Cl. CPC B62B 19/02; B62B 1/20

(57) ABSTRACT

A devise that makes it possible to use common-or-garden wheelbarrow in snow or other slippery conditions. The device can be used on any standard wheelbarrow and deployed in a matter of a few seconds, without any disassembly or adjustment to the wheelbarrow. The device consists of aplastic board, similar to a children's training snowboard, approximately 104 cm (41 inches) long and 28 cm (11 inches) wide, to which a metal cradle is attached in the center to snugly hold the wheel of the wheelbarrow.

### BACKGROUND OF THE INVENTION

My family heats the house with a wood stove. The wood is stored in a shed away from the house and requires the use of a wheelbarrow to transport the wood to the house. When it snows, even as little as 25 mm (1 inch), the wheelbarrow becomes difficult to move when loaded with wood and with snow over 3 inches a wheelbarrow becomes unusable, especially when loaded with 150 pounds of firewood. This problem is experienced by anyone needing to use a wheelbarrow in any slippery condition, such as snow, ice, mud, etc. Homeowners working on their property, DIY enthusiasts, contractors, road workers, farmers, municipal workers, stable owners, and so on face this challenge.

### SUMMARY OF THE INVENTION

Apart from solving the problem of not being able to use a wheelbarrow in snowy or other slippery conditions, the objective of this invention was to be able to be used on any wheelbarrow, regardless of the size of the wheel installed on it; to be deployable without any disassembly of the wheelbarrow; deployable and undeployable easily and quickly; light in weight and consisting of low cost manufacturing, thus enabling the unit to sell for less than the cost of the wheelbarrow it is used on.

The design consists of a board, similar to a child's training snowboard. The board is approximately 104 cm (41 inches) long and 28 cm (11 inches) wide. The cradle, that holds the wheel of the wheelbarrow to the board is positioned in the center of the board. The wheelbarrow wheel drops into the cradle and the invention is ready for use.

### BRIEF DESCRIPTION OF DRAWINGS

FIG. 1—Profile view of invention installed on a wheelbarrow

FIG. 2—Profile view of invention. Part #10 is the snowboard. Parts #11A and 11B represent the wheel cradle. They are a mirror image of each other.

FIG. 3—Plan view of invention. Part #10 is the snowboard. Parts #11A and 11B represent the wheel cradle. They are a mirror image of each other. Part #12 indicates the screw locations holding the cradle arms to part #10, the board. Part #13 is groups of 3 clearance holes either side and each end of part #10, the board. They facilitate the adjustment of the wheel cradle to accommodate the different wheel/tire sizes used by the different wheelbarrows.

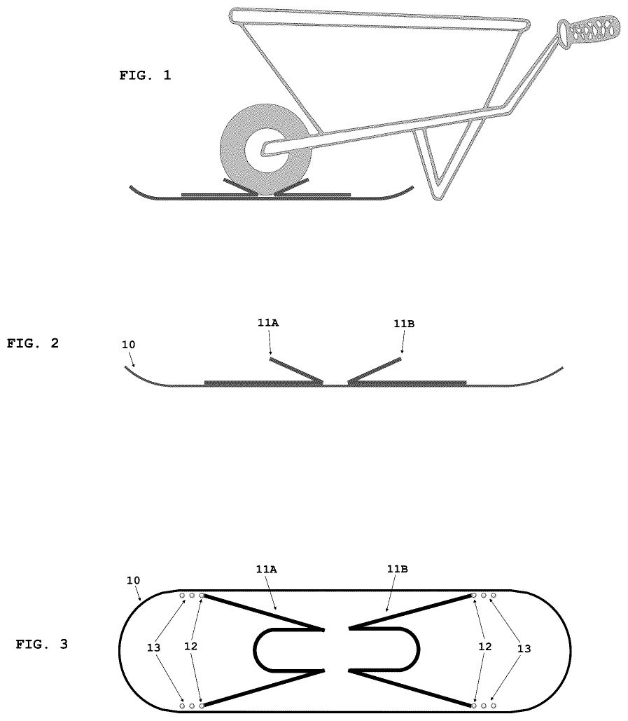

### DETAILED DESCRIPTION OF THE INVENTION

The invention consists of seven parts; one snowboard with twelve holes, four countersink screws and the wheel cradle that consists of two unconnected pieces.

Each cradle piece is made from a single 13 mm (½ inch) mild steel bar, bent into shape. The cradle is attached to the board by four cradle arms with 6 mm (¼ inch) threaded holes, 13 mm (½ inch) from the end of each arm. A 6 mm (¼ inch) countersink screws are inserted from the underneath of the board and screw into the threaded holes of the wheel cradle arms.

The first bend in the construction of each the cradle arms is the 9.5 cm (3¾ inch), internal diameter, semicircle in the middle of the bar, that follows the contour of the wheelbarrow's wheel/tire. The two arms are bent up and back at a 25-degree angle 14 cm (5.5 inch), internal length, from the center of the semicircle to the arm bends. The arms are 30 cm (12 inches) long and bent outwards 12 degrees.

The arms of the wheel cradle address a crucial problem using a snowboard with a loaded wheelbarrow, by making the board ridged and preventing it from flexing up either side of the wheelbarrow wheel. If the arms weren't employed the in the board takes on a U shape in the snow when the wheelbarrow is loaded, which causes the board to get stuck.

The board is a low cost 6 mm (¼ inch) plastic snowboard, similar to training boards used by children. Each end has a 24 cm (9½ inch) radius curve upwards, 18 cm (7 inches) long. It has twelve 6 mm (¼ inch) holes (with clearance for the wheel cradle securing screws), six at each end of the board, three either side. The holes use a countersink on the underside of the board to facilitate a flush finish with the countersink screws. The three holes either side facilitates adjustment of the wheel cradle for the differing wheelbarrow wheel sizes.

Assembly consists of pushing the 6 mm (¼ inch) screws through the appropriate holes of the board and screwing them into the threaded holes in wheel cradle arms.

This design of this invention is a significantly different US patent: U.S. Pat. No. 3,367,674 A, Wheelbarrow Attachment. My invention is better suited to the various wheel/tire sizes used by wheelbarrows. My invention is much easier to and cheaper to manufacture and consists of less parts. My invention is lighter and thus easier to handle.

US patent: U.S. Pat. No. 3,367,674 A uses a ski and not a snowboard. My earlier protypes used a ski which became inoperable when the wheelbarrow was loaded and the snow was deeper than 6 inches as it would sink into the snow.

For additional simplicity of installation of the invention onto the wheelbarrow, the design specifically does not have a front and back, unlick US patent: U.S. Pat. No. 3,367,674 A, thus ensuring installation was guaranteed, quick and easy, i.e., there is no wrong way to install it.

1. A snowboard attachment to enable a common-or-garden wheelbarrow to be used in icy and other slippery environmental conditions, especially with snow depth greater than 5 cm/2 inches and consists of the following.

2. A snowboard, similar in dimension to a child's training snowboard (104 cm/41 inches long and 28 cm/11 inches wide).

3. A wheel cradle, comprising of a front and back hoop to cradle the wheelbarrow's wheel/tire.

4. Each cradle hoop has two arms protruding backward and outward in order to attach to and stiffen the snowboard.

5. The insertion of the wheel in the cradle also keeps the board straight/flat, by preventing the board from flexing upwards in snowy conditions when the wheelbarrow is loaded—this is achieved by the cantilever action forcing the hoops to push against the wheel/tire of the wheelbarrow, in that the wheel/tire prevents the cradle from closing.

6. The ‘universal’ aspect of the invention is further extended by its ability to adjust for differing wheel sizes deployed by the myriad of wheelbarrow designs.
a. The board has twelve clearance countersink holes, six at each end of the board, three either side, for the four countersink screws which attach to the arms of the wheel cradle.
b. The adjustment is achieved by positioning the screws through the appropriate hole for the wheel/tire size, thus moving either cradle piece (parts 11A & 11B in FIGS. 2 & 3).

7. Another aspect of the invention is the exclusion of a front and rear end, due to its symmetrical design. This ensures there's no wrong way to install the invention.

8. The invention can be used on wheelbarrows deploying two wheels, when the wheels are wide enough apart, by using a second Universal Wheelbarrow Snowboard Attachment for the second wheel.
